(19) United States
(12) Patent Application Publication
(10) Pub. No.: US 2026/0359335 A1
(43) Pub. Date: Nov. 12, 2026

(54) SEMANTIC SIMILARITY SEARCH BASED ON HIERARCHICAL EMBEDDINGS

(71) Applicant: SAP SE, Walldorf (DE)

(72) Inventor: Jeffrey HAJEWSKI, Olympia, WA (US)

(21) Appl. No.: 19/203,499

(22) Filed: May 9, 2025

(51) Int. Cl. G06F 16/334; G06F 16/338

(52) U.S. Cl. CPC G06F 16/3344; G06F 16/338

(57) ABSTRACT

Disclosed herein are a system, method, and computer program product embodiments for semantic similarity-based search based on hierarchical embeddings. For example, an embedding representation for a search query is generated. Based on a comparison of the embedding representation to a plurality of document-level embedding representations, a set of candidate documents from a plurality of documents is determined. Each of the plurality of document-level embedding representations is representative of a document of the plurality of documents. A subset of the determined set of candidate documents is determined based on a comparison of the embedding representation to at least one of a respective plurality of section-level embedding representations for each candidate document of the determined set of candidate documents or a respective plurality of concept-level embedding representations for each candidate document of the determined set of candidate documents. A response is outputted to the search query based on the subset.

### BACKGROUND

Traditional keyword-based searches often struggle to capture the nuances of language and context, leading to less accurate results. An alternative approach is to utilize semantic similarity-based searches. Semantic searches aim to understand the meaning behind words and phrases, allowing search engines to provide more contextually relevant results. Unlike traditional keyword-based searches that rely on exact matches, semantic search takes in to account the relationship between words, their contextual significance, and the user's intent behind the query. This is achieved through the use of embeddings, which are numerical representations of words or phrases in a continuous vector space.

A common challenge when utilizing semantic similarity-based searches is encouraging diversity in the search results. Large documents that are searched on may be broken down into smaller chunks for embedding, which results in a high number of embeddings for such documents. The volume of embeddings from a single large document can quickly overwhelm and crowd out embeddings from other documents. This causes a lack of document diversity, where search results are skewed towards the larger documents even when other documents may be more relevant to the search query.

### BRIEF DESCRIPTION OF THE DRAWINGS

The accompanying drawings are incorporated herein and form a part of the specification.

FIG. 1 is a block diagram of a system for providing hierarchical embedding-based document searching, according to some embodiments.

FIG. 2 is a block diagram of a system for performing hierarchical semantic searching of documents using a search engine, according to some embodiments.

FIG. 3 is a flowchart for a method for performing a search using hierarchical embedding representations, according to some embodiments.

FIG. 4 is a flowchart for a method for performing a hierarchical embedding-based search based on section-level and concept-level embedding representations, according to some embodiments.

FIG. 5 is a flowchart for a method for generating a response to a search query using weighted hierarchical document embeddings, according to some embodiments.

FIG. 6 is a block diagram of a system for generating hierarchical embeddings, according to some embodiments.

FIG. 7 illustrates a hierarchical embedding structure representing the organization of embedding representations for a document at different levels of granularity, according to some embodiments.

FIG. 8 is a flowchart for a method for generating concept-level embeddings for a particular candidate document, in accordance with some embodiments.

FIG. 9 is a flowchart for a method for generating section-level embedding representations for a particular candidate document, according to some embodiments.

FIG. 10 is a flowchart for a method for generating section-level embedding representations for a particular candidate document using an unsupervised learning approach, according to some embodiments.

FIG. 11 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are a system, apparatus, device, method and/or computer program product embodiments, and/or combinations and sub-combinations thereof, for semantic similarity-based search based on hierarchical embeddings. For example, embeddings for a corpus of documents on which a search is performed may be generated at multiple levels of granularity (e.g., at the document level, the section level, and the concept level). The hierarchical embedding search-based techniques described herein enable efficient searching by first matching at the document level, then drilling down to relevant sections and specific concepts of the matched documents.

In particular, an embedding representation for a search query is generated. Based on a comparison of the embedding representation to a plurality of document-level embedding representations, a set of candidate documents from a plurality of documents is determined. Each of the plurality of document-level embedding representations is representative of a document of the plurality of documents. A subset of the determined set of candidate documents is determined based on a comparison of the embedding representation to at least one of a respective plurality of section-level embedding representations for each candidate document of the determined set of candidate documents or a respective plurality of concept-level embedding representations for each candidate document of the determined set of candidate documents. A response is outputted to the search query based on the subset.

The hierarchical embedding search-based techniques described herein may provide several practical advantages for document search and retrieval. For example, by generating and storing embeddings at multiple levels of granularity (e.g., document, section, and concept), more efficient and effective semantic search may be achieved than compared to traditional keyword-based approaches or flat embedding methods. That is, the hierarchical embedding search-based techniques enable efficient searching by first matching at the document level, then drilling down to relevant sections and specific concepts. This enables the system to quickly identify the most relevant documents and content, thereby improving both search speed and accuracy compared to traditional keyword or flat embedding approaches. Moreover, the techniques described herein reduces the amount of compute resources utilized to perform searches. Particularly, by enabling initial filtering or matching at the document-level before drilling down to more detailed section-level and/or concept-level analysis, the number of embedding comparisons performed at each stage is reduced as a result of the filtering. Accordingly, the compute resources (e.g., processing cycles, memory, I/O, etc.) utilized to perform the search techniques described herein are reduced.

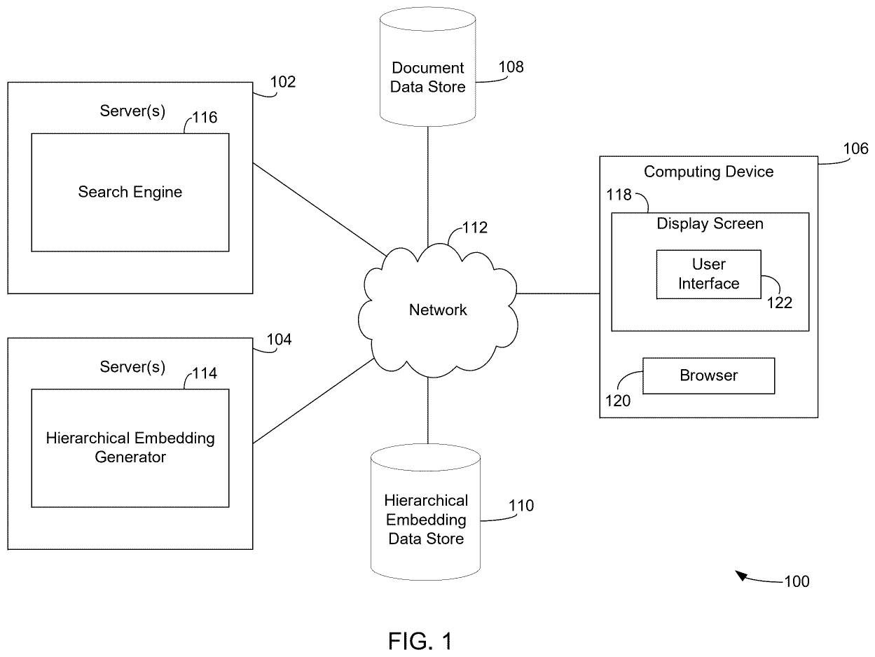

FIG. 1 is a block diagram of a system 100 for providing hierarchical embedding-based document searching, according to some embodiments. System 100 may include one or more servers 102, one or more servers 104, a computing device 106, a document data store 108, and a hierarchical embedding data store 110. Each of server(s) 102, server(s) 104, computing device 106, document data store 108, and/or hierarchical embedding data store 110 may be communicatively coupled via a network 112. Network 112 may include any suitable combination of local area and/or wide area networks using both wired and/or wireless communication systems. Network 112 may include local area networks (LANs), wide area networks (WANs), the Internet, cellular networks, satellite networks, or any other suitable communication networks.

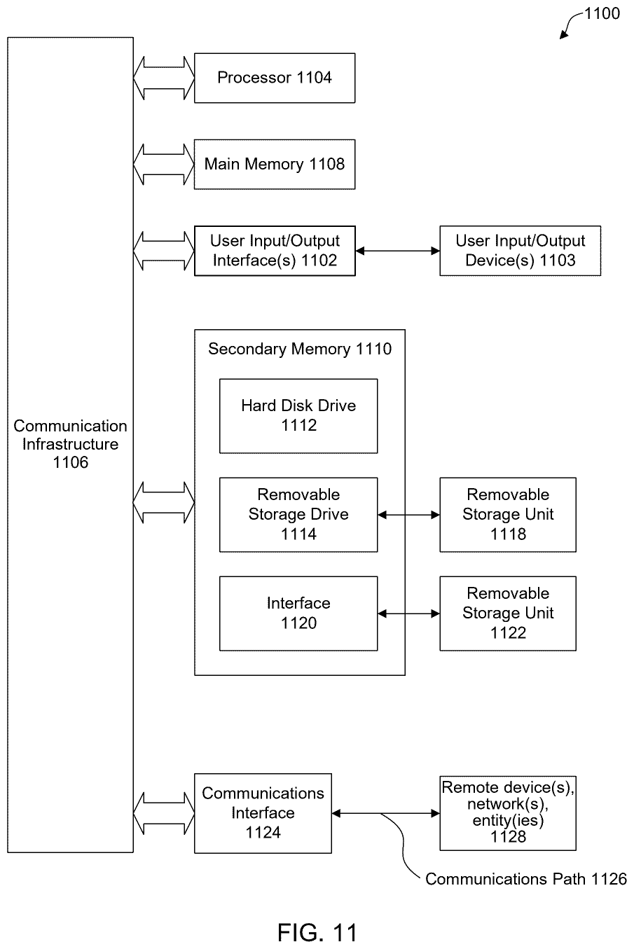

In some embodiments, server(s) 102 may include a search engine 116. Search engine 116 may be configured to process search queries and generate responses based on hierarchical document embeddings of the documents. Search engine 116 may implement hierarchical search techniques to efficiently identify relevant documents and content. For example, search engine 116 may first compare an embedding of a search query to document-level embeddings to find candidate documents, then drill down to compare against section-level and/or concept-level embeddings within those documents. Search engine 116 may be implemented by processing logic that can include hardware (e.g., circuitry, dedicated logic, programmable logic, and/or microcode), software (e.g., instructions executing on a processing device), or a combination thereof. In some embodiments, search engine 116 is implemented in one or more software processes executing on one or more processor-based computer systems, such as computer system 1100 as described below in reference to FIG. 11.

Search engine 116 may leverage natural language processing and machine learning techniques to understand the semantic meaning and context of the search queries. This enables search engine 116 to perform more than simple keyword matching and to identify conceptually relevant results, even if the exact query terms are not present in the documents.

Server(s) 104 may include a hierarchical embedding generator 114 for generating multi-level embeddings for each document stored in document data store 108. Hierarchical embedding generator 114 may be implemented by processing logic that can include hardware (e.g., circuitry, dedicated logic, programmable logic, and/or microcode), software (e.g., instructions executing on a processing device), or a combination thereof. In some embodiments, hierarchical embedding generator 114 is implemented in one or more software processes executing on one or more processor-based computer systems, such as computer system 1100 as described below in reference to FIG. 11.

For each document, hierarchical embedding generator 114 may utilize techniques such as recursive neural networks or hierarchical attention networks to create embeddings that capture the document structure. Hierarchical embedding generator 114 may also utilize techniques such as topic modeling or hierarchical clustering to identify conceptual hierarchies within documents. For example, hierarchical embedding generator 114 may generate a document-level embedding representing the entire document. Hierarchical embedding generator 114 may also process a document to identify different sections based on the document structure or by using unsupervised learning techniques. For each identified section, hierarchical embedding generator 114 may generate section-level embeddings representative of the identified sections. Additionally, hierarchical embedding generator 114 may identify different concepts described within each document (e.g., by utilizing large language model-based techniques) and generate concept-level embeddings for those identified concepts. The foregoing techniques may allow for the fine-grained representation of specific ideas within the document. In some embodiments, hierarchical embedding generator 114 may utilize techniques such as recursive autoencoders or hierarchical transformers to create embeddings that capture document structure at multiple levels of granularity. Server(s) may store the generated hierarchical embeddings in hierarchical embedding data store 110.

The hierarchical embedding techniques described above may provide several practical benefits for document search and retrieval. By generating and storing embeddings at multiple levels of granularity (e.g., document, section, and concept), more efficient and effective semantic search may be achieved than compared to traditional keyword-based techniques or flat embedding methods. That is, the hierarchical embedding techniques may enable efficient searching by first matching at the document level, then drilling down to relevant sections and specific concepts. This may allow the system to quickly identify the most relevant documents and content, potentially improving both search speed and accuracy compared to traditional keyword or flat embedding approaches.

Computing device 106 may comprise devices, such as a desktop computer, laptop, smartphone, tablet, etc. Computing device 106 may include a display screen 118 for presenting a user interface 122 within a browser 120. A user may enter search queries and view search results via user interface 122. The user interface may incorporate features such as auto-complete suggestions and query refinement options. User interface 122 may present search results and allow the user to navigate through and interact with the hierarchically structured embedding representations retrieved in response to their queries. It may incorporate visualizations such tree diagrams or heatmaps to represent the hierarchical relevance of search results. In some embodiments, user interface 122 may be configured to provide a conversational AI interface, allowing users to refine their queries and explore search results through natural language dialogue. This may enhance the user experience and enable more interactive and exploratory search sessions.

As described above, document data store 108 may contain the corpus of documents to be searched. The documents stored in document data store 108 may include various types of files such as text documents, spreadsheets, presentations, PDFs, web pages, emails, and other formats containing searchable content. As also described above, hierarchical embedding data store 110 may store the document-level, section-level, and concept-level embeddings generated by hierarchical embedding generator 114 for each of the documents in document data store 108. Each of document data store 108 and hierarchical embedding data store 110 may be implemented as a database, file system, or other type of storage system capable of storing and retrieving document data. In some embodiments, each of document data store 108 and hierarchical embedding data store 110 may be implemented using a distributed storage system and/or a cloud-based system. It is noted that document data store 108 and hierarchical embedding data store 110 may be incorporated within the same data store or may each be separate data stores, as depicted in FIG. 1

Each of server(s) 102 and 104 may include one or more physical or virtual servers that host instances of search engine 116 and hierarchical embedding generator 114, respectively. Each of server(s) 102 and 104 may be implemented using one or more computing devices, such as rack-mounted servers, blade servers, desktop computers, laptop computers, or any other suitable computing devices.

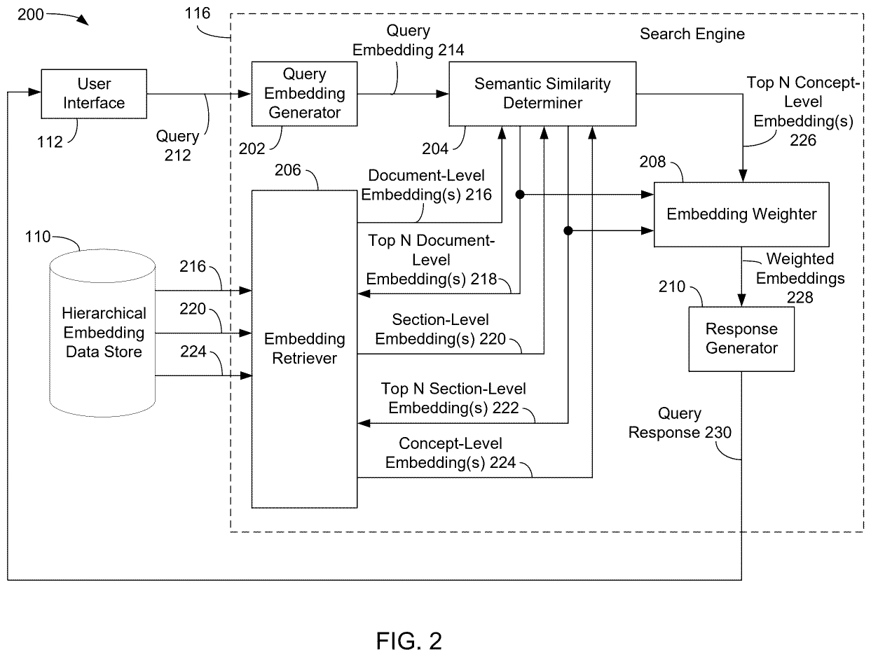

FIG. 2 is a block diagram of a system 200 for performing hierarchical semantic searching of documents using a search engine, according to some embodiments. System 200 may include hierarchical embedding data store 110, user interface 112, and search engine 116.

User interface 112 may be configured to receive a search query from a user (e.g., via computing device 106). In some embodiments, user interface 112 may be configured to provide query formulation options, such as filters for document types, date ranges, or specific domains. User interface 112 may also provide query suggestions or auto-completion based on popular searches or the user's search history. User interface 112 may include interactive elements that enable users to refine their search results in real-time, such as sliders to adjust the balance between document-level, section-level, and concept-level relevance. User interface 122 may provide the search query (shown as query 212) to search engine 116 (e.g., via network 112).

Search engine 116 may be configured to perform semantic search operations using the hierarchical embedding representations of documents. As shown in FIG. 2, search engine 116 may include a query embedding generator 202, a semantic similarity determiner 204, an embedding retriever 206, an embedding weighter 208, and a response generator 210. Each of query embedding generator 202, semantic similarity determiner 204, embedding retriever 206, embedding weighter 208, and response generator 210 may be implemented by processing logic that can include hardware (e.g., circuitry, dedicated logic, programmable logic, and/or microcode), software (e.g., instructions executing on a processing device), or a combination thereof. In some embodiments, each of query embedding generator 202, semantic similarity determiner 204, embedding retriever 206, embedding weighter 208, and response generator 210 is implemented in one or more software processes executing on one or more processor-based computer systems, such as computer system 1100 as described below in reference to FIG. 11

Query embedding generator 202 may be configured to generate a query embedding 214 representative of search query 212. In some embodiments, query embedding 214 may comprise a semantic vector representation of search query 212 in the same embedding space as the hierarchical document embeddings stored in data store 110. In some embodiments, query embedding generator 202 may utilize multiple embedding models specialized for different types of queries or domains. For instance, query embedding generator 202 may use one model for technical queries and another for general knowledge queries. Query embedding generator 202 may automatically select the most appropriate model based on an analysis of search query 212 or may allow users to explicitly specify their query type. In some embodiments, query embedding generator 202 may utilize various techniques, such as transformer-based models (e.g., Word2Vec, GloVe embeddings, Universal Sentence Encoder, etc.) to generate query embedding 214.

Semantic similarity determiner 204 may be configured to compare query embedding 214 to the hierarchical embeddings stored in data store 110 to determine candidate documents. For example, semantic similarity determiner 204 may initially compare query embedding 214 to document-level embedding(s) 216 (corresponding to the documents stored in data store 108) to identify a set of top N document-level embeddings 218 that are most semantically similar to the query. Document-level embedding(s) 216 may be retrieved from data store 110 by embedding retriever 206. Semantic similarity determiner 204 may then provide the top N document-level embedding(s) 218 to embedding retriever 206, and embedding retriever 206 may obtain section-level embedding(s) 220 for each of document corresponding to the top N document-level embedding(s) 218. Semantic similarity determiner 204 may then compare the query embedding to section-level embeddings 220 associated with the top N documents (corresponding to the top N document-level embeddings 218) to identify top N section-level embeddings 222 for each of the top N documents. Semantic similarity determiner 204 may then provide the top N section-level embedding(s) 222 to embedding retriever 206, and embedding retriever 206 may obtain concept-level embedding(s) 224 for each of section and document corresponding to the top N section-level embedding(s) 222 and top N document-level embedding(s) 218, respectively. Semantic similarity determiner 204 may further compare query embedding 214 to concept-level embeddings 224 to identify top N concept-level embeddings 226 most relevant to the query.

In some embodiments, semantic similarity determiner 204 is configured to utilize one or more techniques for determining a measure of semantic similarity between query embedding 214 and each of document-level embedding(s) 216, section-level embedding(s) 220, and concept-level embedding(s) 224. Such techniques include, but are not limited to, cosine similarity-based techniques, Euclidean distance-based techniques, Manhattan distance-based techniques, etc.

In some embodiments, semantic similarity determiner 204 is configured to utilize adaptive similarity thresholds. In accordance with such embodiments, instead of selecting a fixed number of top results, semantic similarity determiner 204 may dynamically adjust the number of results based on the similarity scores. For example, semantic similarity determiner 204 may select more results if many documents have high similarity scores, or fewer if there's a clear drop-off in relevance. This technique may ensure that truly relevant results are considered, regardless of the size of the document collection.

Embedding weighter 208 may be configured to apply weights to the identified embeddings at each level (e.g., top N concept-level embedding(s) 226, top N document-level embedding(s) 218, and/or top N section-level embedding(s) 222) based on factors such as the specificity of query 212, e.g., determined by a large language model utilized by search engine 116. For example, search engine 116 may analyze the search query to determine how specific or general the query is. For example, a query asking for a particular data point such as “What is the MPG of a particular hybrid vehicle?” may be considered highly specific, while a query such as “Tell me about IT software” may be considered more general. Embedding weighter 208 may utilize the level of specificity of a query to generate a set of weighted embeddings 228 across top N concept-level embedding(s) 226, top N document-level embedding(s) 218, and/or top N section-level embedding(s) 222. The weighting of different embedding levels may provide flexibility in emphasizing document-level, section-level or concept-level relevance as appropriate for each query.

In some embodiments, embedding weighter 208 may utilize a machine learning model trained on user feedback and search patterns to dynamically adjust the weights. The machine learning model may take into account factors such as query complexity, user expertise level, historical performance of different weighting strategies for similar queries, etc.

Response generator 210 may generate a response to search query 212 (query response 230) based on weighted embeddings 228. Response generator 210 may utilize the large language model to synthesize information from content corresponding to the relevant weighted embeddings 228 into a natural language response. For example, response generator 210 may implement a multi-stage response generation process. First, response generator 210 may extract information pertaining to search query 212 from the most relevant embeddings. Then, response generator 210 may use the large language model to generate query response 230. Response generator 210 may then compare query response 230 against the original source documents to ensure accuracy. This technique may combine the fluency of language model generation with the reliability of direct information retrieval. Examples of query response 230 include, but are not limited to, providing direct answers, summarizing key points of relevant document, or offering a list of relevant passages with explanations.

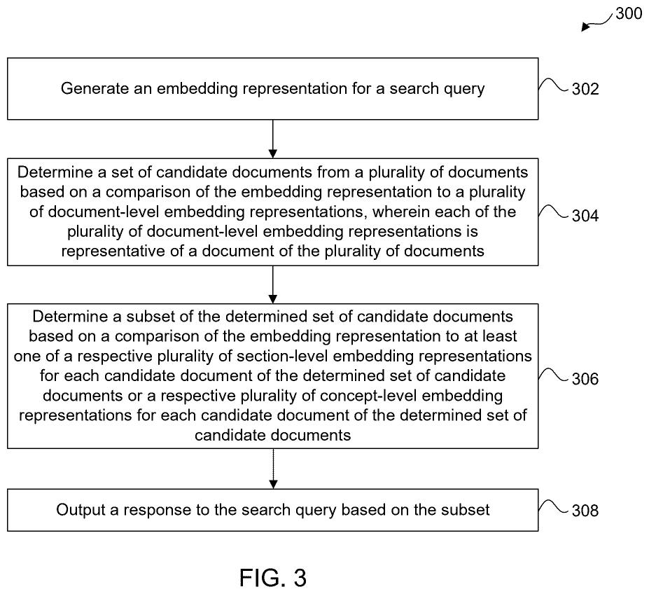

FIG. 3 is a flowchart for a method 300 for performing a search using hierarchical embedding representations, according to some embodiments. Method 300 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1 and 2. However, method 300 is not limited to that example embodiment.

At 302, query embedding generator 202 of search engine 116 may generate an embedding representation of search query 212. For example, query embedding generator 202 may convert the natural language of search query 212 into a dense vector representation in a high-dimensional embedding space. The vector representation may represent the semantic meaning of search query 212 in a high-dimensional vector space.

In some embodiments, query embedding generator 202 may perform preprocessing on search query 212 before generating query embedding 214, such as tokenization and normalization, stopword removal, entity recognition and linking, or query expansion using synonyms or related terms.

At 304, semantic similarity determiner 204 may determine a set of candidate documents from a plurality of documents based on a comparison of embedding representation (e.g., query embedding 214) to a plurality of document-level embedding representations (e.g., document-level embedding(s) 216). Each document-level embedding representation may be representative of a document of the plurality of documents (e.g., stored in data store 108). In some embodiments, the top N most similar document-level embeddings 218 is selected as the set of candidate documents.

At 306 semantic similarity determiner 204 may determine a subset of the candidate documents based on a comparison of the embedding representation (e.g., query embedding 214) to at least one of a respective plurality of section-level embedding representations (e.g., section-level embedding(s) 220) for each candidate document of the determined set of candidate documents or a respective plurality of concept-level embedding representations (e.g., concept-level embedding(s) 224) for each candidate of the determined set of candidate documents.

In some embodiments, a particular document-level embedding representation, of the plurality of document-level embedding representations, of a particular document of the plurality of documents is based on a combination (e.g., an average) of section-level embedding representations of the particular document.

At 308, response generator 210 may output a response to the search query (e.g., query response 230) based on the subset of documents determined in step 306. Response generator 210 may leverage the large language model to synthesize an answer using the most relevant sections and concepts identified through the hierarchical embedding comparisons. This technique may enable the generation of concise, targeted responses that draw from the most pertinent information across the document corpus. For example, after narrowing down the candidate documents through document-level, section-level, and/or concept-level embedding comparisons, search engine 116 may have identified the most relevant content to query 212. Search engine 116 may then analyze this subset of highly relevant content to generate a natural language response that directly addresses the user's query.

Query response 230 may take different forms depending on the implementation. For example, query response 230 may include a summary paragraph synthesizing key information from the relevant documents, extracted quotes or passages from the most relevant sections, links or references to the source documents with relevant sections highlighted, a list of key facts or points related to the query topic, follow-up questions to help refine or expand on the initial query, a structured output summarizing relevant data, or a multi-modal response combining text, images, and other media from the source documents.

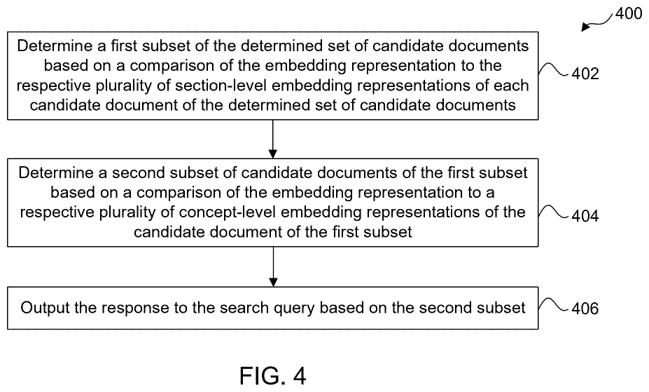

FIG. 4 is a flowchart for a method 400 for performing a hierarchical embedding-based search based on section-level and concept-level embedding representations, according to some embodiments. Method 400 may be performed by processing logic that can comprise hardware (e.g., circuitry, dedicated logic, programmable logic, microcode), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1 and 2. However, method 400 is not limited to those example embodiments.

At 402, semantic similarity determiner 204 may determine a first subset of the determined set of candidate documents based on a comparison of the embedding representation (e.g., query embedding 214) to the respective plurality of section-level embedding representations (e.g., section-level embeddings 220) of each candidate document of the determined set of candidate documents.

At 404, semantic similarity determiner 204 may determine a second subset of candidate documents of the first subset based on a comparison of the embedding representation (e.g., query embedding 214) to a respective plurality of concept-level embedding representations (e.g., concept-level embedding(s) 224) of the candidate documents of the first subset. This step may further narrow down the results by comparing the query embedding to concept-level embeddings within the sections identified in the previous step.

At 406, response generator 210 may output the response to the search query based on the second subset.

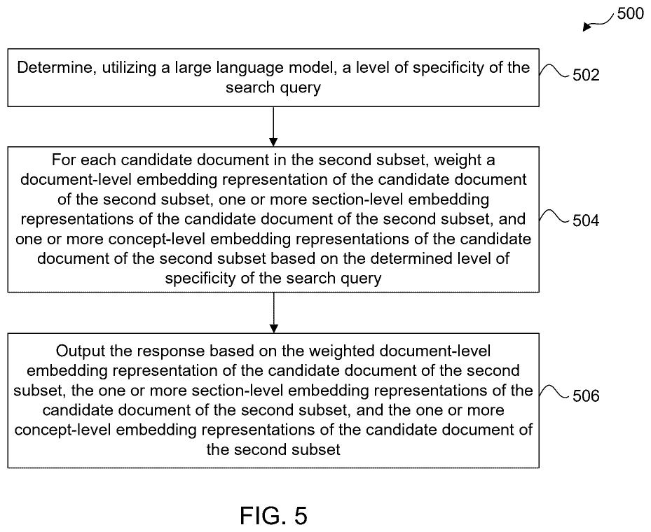

FIG. 5 is a flowchart for a method 500 for generating a response to a search query using weighted hierarchical document embeddings, according to some embodiments. Method 500 may be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as may be understood by a person of ordinary skill in the art.

Method 500 shall be described with reference to FIGS. 1 and 2. However, method 500 is not limited to that example embodiment.

At 502, search engine 116 may, determine utilizing a large language model, a level of specificity of search query 212. The large language model may be trained on a wide variety of queries and their associated specificity levels to make this determination. It may analyze factors such as the number of qualifying terms, presence of numerical values or precise names, and overall query length to gauge specificity. This analysis may be performed by the query embedding generator 202 of search engine 116.

In some embodiments, the large language model may use a multi-class classification approach to categorize queries into different levels of specificity, such as “highly specific,” “moderately specific,” “general,” and “very general.” This classification may be based on a combination of features extracted from the query text, including but not limited to query length, presence of specific entities, use of numerical values or units of measurement, presence of technical or domain-specific terminology, use of question words, and grammatical structure of the query.

The large language model may be trained on a large dataset of manually labeled queries to learn the patterns associated with different levels of specificity. During inference, it may then assign a specificity score or category to each incoming query.

At 504, embedding weighter 208 may, for each candidate document in the second subset, weight a document-level embedding representation (e.g., top N document-level embedding(s) 218) of the candidate document of the second subset, one or more section-level embedding representations (e.g., top N section-level embedding(s) 222) of the candidate document of the second subset, and one or more concept-level embedding representations (e.g., top N concept-level embedding(s) 226) of the candidate document of the second subset based on the determined level of specificity of search query 212. For more specific queries, embedding weighter 208 may apply a greater weight to the concept-level embeddings, while for more general queries, embedding weighter 208 may apply a greater weight to the document-level embeddings.

In some embodiments, instead of using predetermined weight distributions, embedding weighter 208 may utilize a machine learning model, such as a neural network, to dynamically determine the optimal weights for each level of embedding based on the specificity of query 212 and other contextual factors. This model may be trained on historical query-response pairs and their associated user satisfaction metrics to learn the most effective weighting strategy for different types of queries.

At 506, response generator 210 may output the response based on the weighted document-level embedding representation of the candidate document of the second subset, the one or more section-level embedding representations of the candidate document of the second subset, and the one or more concept-level embedding representations of the candidate document of the second subset (collectively shown as weighted embeddings 228).

Response generator 210 may generate query response 230 based on these weighted embeddings, taking into account the varying levels of relevance at the document, section, and concept levels as determined by the weighting process. This enables response generator 210 to provide responses that are appropriately tailored to the specificity of the user's query, drawing on the most relevant hierarchical levels of the document embeddings.

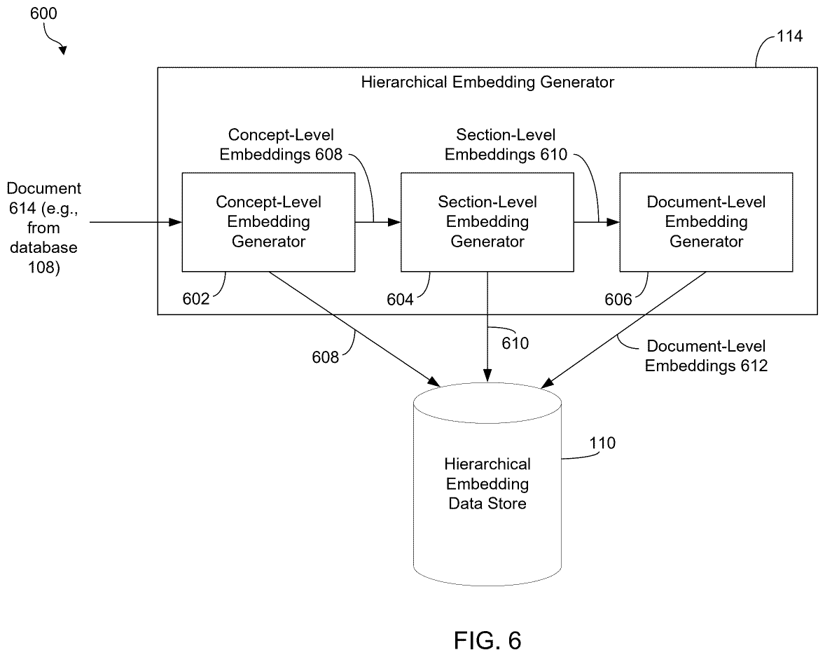

FIG. 6 is a block diagram of a system 600 for generating hierarchical embeddings, according to some embodiments. As shown in FIG. 6, system 600 may include a hierarchical embedding generator 114 and hierarchical embedding data store 110. Hierarchical embedding generator 114 may comprise a concept-level embedding generator 602, a section-level embedding generator 604, and a document-level embedding generator 606. Each of concept-level embedding generator 602, section-level embedding generator 604, and document-level embedding generator 606 may be implemented by processing logic that can include hardware (e.g., circuitry, dedicated logic, programmable logic, and/or microcode), software (e.g., instructions executing on a processing device), or a combination thereof. In some embodiments, each of concept-level embedding generator 602, section-level embedding generator 604, and document-level embedding generator 606 is implemented in one or more software processes executing on one or more processor-based computer systems, such as computer system 1100 as described below in reference to FIG. 11.

Hierarchical embedding generator 114 may be configured to receive a document 614 (e.g., from document data store 108) and provide document 614 to concept-level embedding generator 602. Concept-level embedding generator 602 may be configured to identify different concepts described within document 614, for example by utilizing a large language model to analyze the content. For each identified concept, concept-level embedding generator 602 may generate a corresponding concept-level embedding 608 that semantically represents that concept.

For example, given a document about renewable energy, concept-level embedding generator 602 may identify concepts such as “solar power”, “wind energy”, “hydroelectric power”, etc. Concept-level embedding generator 602 may then generate a unique embedding vector to represent each of those concepts based on their contextual usage and meaning within document 612. Concept-level embeddings 608 may capture fine-grained semantic information about the key ideas and topics covered in the document. Concept-level embeddings 608 may form the lowest, most granular level of the hierarchical embedding structure. Concept-level embedding generator 602 may store concept-level embeddings 608 in data store 110.

In some embodiments, concept-level embedding generator 602 may use a sliding window technique to generate embeddings for overlapping text segments, allowing it to capture concepts that span multiple sentences or paragraphs. This technique could help identify more complex or nuanced concepts that may not be confined to a single section of text.

Section-level embedding generator 604 may identify different sections of text within the document 614, either based on the document's organizational structure (e.g. headings, paragraphs, etc.) or by using unsupervised learning techniques to cluster similar text. For each identified section, section-level embedding generator 604 may generate chunk-level embeddings for chunks of text within that section, and then combine those chunk-level embeddings to create a section-level embedding 610 representing the overall semantic meaning of that section. Section-level embedding generator 604 may store section-level embeddings 610 in data store 110.

For documents with a clear organizational structure (e.g., by using headings), section-level embedding generator 604 may use those headings to delineate sections. For unstructured documents, section-level embedding generator 604 may utilize clustering techniques (e.g., K-means clustering) to group semantically similar chunks of text into sections. Section-level embeddings 610 may provide an intermediate representation between the fine-grained concept-level embeddings and the high-level document embedding.

In some embodiments, section-level embedding generator 604 may utilize a graph-based technique to identify sections. For example, section-level embedding generator 604 may generate a graph where nodes represent chunks of text and edges represent semantic similarity between chunks. By applying community detection algorithms to this graph, section-level embedding generator 604 may identify clusters of related text that form coherent sections, including documents without clear structural demarcations.

Document-level embedding generator 606 may combine section-level embeddings 610 generated by section-level embedding generator 604 to produce a document-level embedding 612 that represents the semantic content of the entire document 614. For example, document-level embedding generator 606 may combine or aggregate section-level embeddings 610 to create a single embedding vector that represents the entire document 614. This aggregation process may enables document-level embedding 612 to capture high-level semantic information about the overall content and topics of document 614, while still incorporating the more granular information from the section-level embeddings 610.

Document-level embedding generator 606 may use techniques such as averaging, weighted averaging, or more sophisticated aggregation methods to combine the section-level embeddings into a unified document representation. Document-level embedding generator 606 may store document-level embeddings 612 in data store 110. Document-level embeddings 612 may be stored in the hierarchical embedding data store 110 along with the corresponding section-level and concept-level embeddings, forming a multi-scale representation of the document's content that can be leveraged during the search process.

In some embodiments, the system 600 is configured to process non-textual documents. For instance, system 600 may incorporate image analysis techniques to generate embeddings for visual content within documents, or audio processing methods to create embeddings for spoken content in video or audio files. These multi-modal embeddings may be integrated into the hierarchical structure, allowing for semantic search across different types of content.

In some embodiments, different levels of embedding generation are parallelized across multiple computing devices, with document-level embedding generator 606 aggregating results from distributed section-level embedding generators 604 and/or concept-level embedding generators 606. This enables system 600 to scale efficiently to handle very large document collections or high-throughput document processing scenarios.

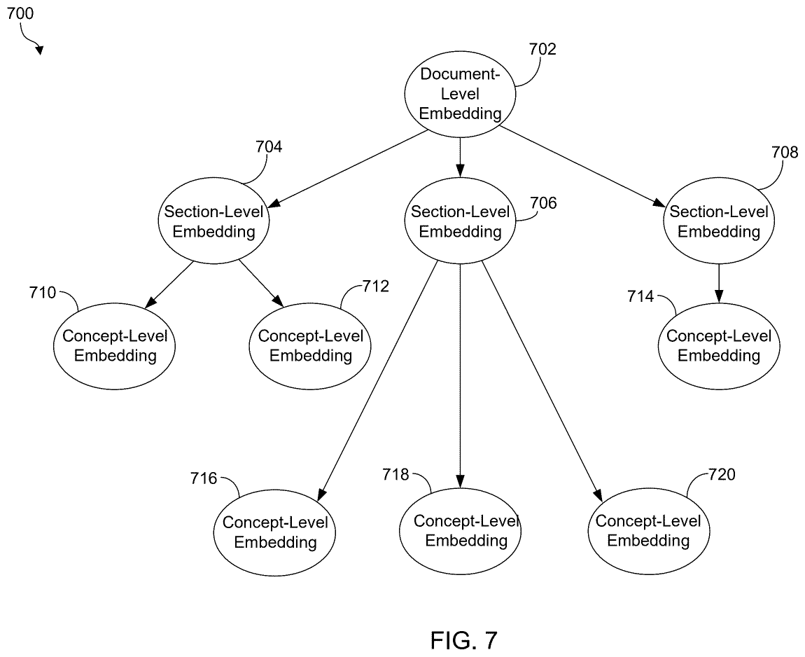

FIG. 7 illustrates a hierarchical embedding structure 700 representing the organization of embedding representations for a document at different levels of granularity, according to some embodiments. In some embodiments, the structure may include a document-level embedding 702 at the top level, which may provide an overall representation of the entire document. This document-level embedding 702 may be associated with multiple section-level embeddings 704, 706, and 708, each potentially representing a distinct section or portion of the document.

Each of section-level embeddings 704, 706, and 708 may be further associated with concept-level embeddings, providing more fine-grained representations of the document's content. For example, section-level embedding 704 may be associated with concept-level embeddings 710 and 712, section-level embedding 706 may be associated with concept-level embeddings 714 and 716, and section-level embedding 708 may be associated with concept-level embeddings 718 and 720. Each of concept-level embeddings 710 and 712 represent distinct concepts associated with a section represented by section-level embedding 704. Each of concept-level embeddings 716, 718, and 720 represent distinct concepts associated with a section represented by section-level embedding 706. Concept-level embedding 714 represents a distinct concept associated with a section represented by section-level embedding 708.

In one embodiment, these concept-level embeddings may be generated using a combination of named entity recognition (NER) and topic modeling techniques. NER could identify specific entities (e.g., people, organizations, locations) mentioned in the text, while topic modeling (e.g., Latent Dirichlet Allocation) may uncover broader themes. The resulting concepts could then be embedded using a pre-trained language model to create the concept-level embeddings.

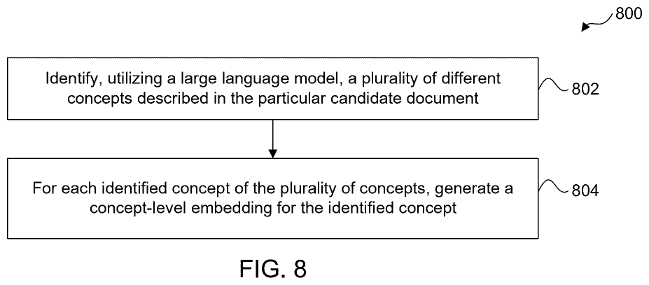

FIG. 8 is a flowchart for a method 800 for generating concept-level embeddings for a particular candidate document, in accordance with some embodiments. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to FIGS. 1 and 6. However, method 800 is not limited to those example embodiments.

At 802, concept-level embedding generator 602 may identify, utilizing a large language model, a plurality of different concepts described in the particular candidate document (e.g., document 614). The large language model may analyze the semantic content of document 614 to determine distinct topics, ideas, or subject matter discussed throughout the text. For example, if document 614 is about renewable energy, the large language model may identify concepts like solar power, wind energy, hydroelectric power, etc. The large language model may utilize techniques such as semantic analysis, topic modeling, or named entity recognition to extract key concepts from the text.

In some embodiments, concept-level embedding generator 602 utilizes a hierarchical topic modeling technique. This technique may first identify broad, overarching themes in document 614, and then progressively drill down to more specific subtopics and concepts. For example, given a document about artificial intelligence, the model might first identify high-level concepts such as “machine learning” and “neural networks”, then further break these down into more specific concepts like “supervised learning”, “deep learning”, “convolutional neural networks”, etc.

In some embodiments, concept-level embedding generator 602 utilizes a sliding window technique, where concept-level embedding generator 602 analyzes chunks of text (E.g., a group of words, a sentence, a paragraph) sequentially, identifying concepts within each chunk and tracking how they evolve or change throughout document 614. This may be particularly useful for long documents where topics and concepts may shift or develop over the course of the text.

Concept-level embedding generator 602 may also incorporate domain-specific knowledge or ontologies to enhance concept identification in specialized fields. For instance, when analyzing medical documents, concept-level embedding generator 602 may be augmented with medical terminologies and relationships to more accurately identify and categorize medical concepts.

At 804, concept-level embedding generator 602, for each identified concept of the plurality of different concepts, may generate a concept-level embedding (e.g., concept-level embedding 608) for the identified concept. To generate concept-level embeddings 602, concept-level embedding generator 602 may convert the textual description of the concept into a dense vector of floating point numbers. Embedding techniques that may be utilized may include Word2Vec, GloVe, or more other transformer-based models, such as BERT.

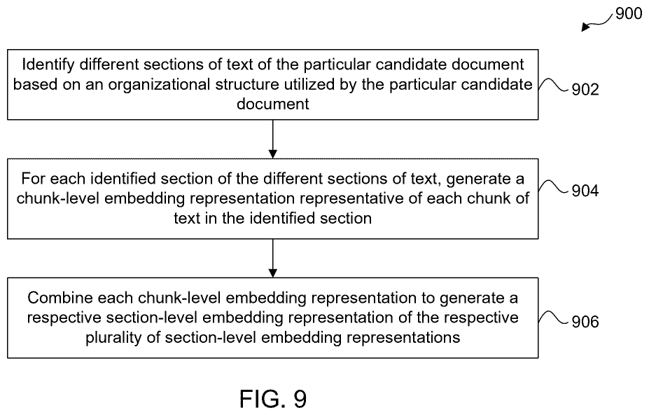

FIG. 9 is a flowchart for a method 900 for generating section-level embedding representations for a particular candidate document, according to some embodiments. Method 900 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as may be understood by a person of ordinary skill in the art.

Method 900 shall be described with reference to FIGS. 1 and 6. However, method 900 is not limited to that example embodiment.

At 902, section-level embedding generator 604 may identify different sections of text of the particular candidate document (e.g., document 614) based on an organizational structure utilized by the particular candidate document. For example, hierarchical embedding generator 114 may analyze the structure and formatting of a document 614 retrieved from the document data store 108 to identify distinct sections. This step may analyze the document structure to determine logical sections, such as chapters, headings, or other content divisions used to organize the information. For a word processing document, sections may correspond to chapters, headings, or major topic divisions. For a spreadsheet document, sections may correspond to worksheet tabs or groups of related columns and/or rows.

In some embodiments, section-level embedding generator 604 utilizes natural language processing techniques to identify linguistic markers that may indicate section boundaries, such as transitional phrases or topic sentences. This technique can be particularly useful for documents with less explicit structural formatting.

In some embodiments, for documents with a table of contents, section-level embedding generator 604 may leverage this information to automatically map out the document's structure and identify major sections and subsections. This technique may be especially effective for longer, more complex documents such as academic papers or technical manuals.

In some embodiments, section-level embedding generator 604 utilizes one or more machine learning models trained on large corpora of documents to recognize common structural patterns and section delineations across different document types. This may allow for more adaptive and generalizable section identification across diverse document formats and styles.

At 904, section-level embedding generator 604, for each identified section of the different sections of text, may generate a chunk-level embedding representation representative of each chunk of text in the identified section.

In some embodiments, section-level embedding generator 604 may use a sliding window technique to generate overlapping chunks of text, which can help capture context at the boundaries between chunks. The size of this sliding window may be dynamically adjusted based on the document's content and structure.

In some embodiments, section-level embedding generator 604 may use sentence-level chunking, where each sentence within a section may be treated as a separate chunk. This technique may be particularly effective for documents where individual sentences carry significant semantic weight, such as legal contracts or scientific abstracts.

The embedding generation process utilized by section-level embedding generator 604 for each chunk may utilize various natural language processing techniques. One technique could leverage pre-trained language models such as BERT or GPT to generate contextual embeddings for each chunk. These models may capture nuanced semantic meanings based on the surrounding context. Alternatively, section-level embedding generator 604 may use domain-specific embedding models that may have been fine-tuned on particular types of documents or subject areas.

At 906, section-level embedding generator 604 may combine each chunk-level embedding representation to generate a respective section-level embedding representation of the respective plurality of section-level embedding representations. For example, once the chunk-level embedding representations are generated for each chunk of text in an identified section in step 904, these chunk-level embeddings can be combined to create a single section-level embedding that represents the entire section. One technique for combining chunk-level embeddings may include averaging of all chunk embeddings within a section. Another technique may utilize a recurrent neural network (RNN) or transformer model to process the sequence of chunk embeddings and generate a section-level embedding that captures both the content and the sequential relationships between chunks.

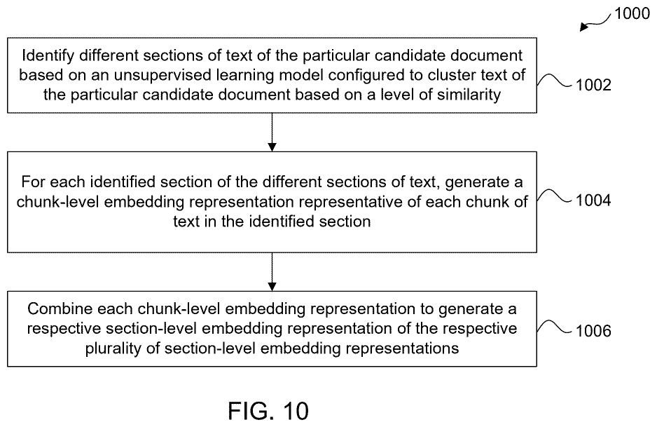

FIG. 10 is a flowchart for a method 1000 for generating section-level embedding representations for a particular candidate document using an unsupervised learning technique, according to some embodiments. Method 1000 can be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as may be understood by a person of ordinary skill in the art.

Method 1000 shall be described with reference to FIGS. 1 and 6. However, method 1000 is not limited to that example embodiment.

At 1002, section-level embedding generator 604 may identify different sections of text of the particular candidate document based on an unsupervised learning model configured to cluster text of the particular candidate document based on a level of similarity. This step may utilize an unsupervised machine learning technique to automatically segment the text of a candidate document into conceptually similar sections, without relying on any predefined document structure or manual annotations.

In some embodiments, the unsupervised learning model of section-level embedding generator 604 may utilize various clustering techniques to group portions of text that are semantically related. For example, a k-means clustering algorithm could be applied to vector representations of text chunks to identify clusters of similar content. The number of clusters (K, where K is any positive integer) may be dynamically determined based on metrics like silhouette score or elbow method. Other clustering algorithms that could be used may include hierarchical clustering, DBSCAN (Density-Based Spatial Clustering of Applications with Noise), or Gaussian mixture models.

In some embodiments, section-level embedding generator 604 may utilize topic modeling techniques such as Latent Dirichlet Allocation (LDA) to identify thematic clusters within document 614. This technique may be particularly effective for longer documents with diverse subject matter.

At 1004, section-level embedding generator 604, for each identified section of the different sections of text, section-level embedding generator 604 may generate a chunk-level embedding representation that is representative of each chunk of text in the identified section. Section-level embedding generator 604 may utilize various techniques for generating section-level embeddings 610, including, but not limited to word embeddings, sentence transformers, paragraph vectors, contextualized embeddings, etc.

At step 1006, section-level embedding generator 604 may combine each chunk-level embedding representation to generate a respective section-level embedding representation of the respective plurality of section-level embedding representations. This step may aggregate the fine-grained semantic information from chunks into a more holistic representation of each document section.

Several techniques may be used by the embedding generator 106 for combining chunk-level embeddings into section-level representations, including, but not limited to, averaging, weighted averaging, concatenation, etc.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof.

Computer system 1100 may include one or more processors (also called central processing units, or CPUs), such as a processor 1104. Processor 1104 may be connected to a communication infrastructure or bus 1106.

Computer system 1100 may also include user input/output device(s) 1103, such as monitors, keyboards, pointing devices, etc., which may communicate with communication infrastructure 1106 through user input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random access memory (RAM). Main memory 1108 may include one or more levels of cache. Main memory 1108 may have stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 may read from and/or write to removable storage unit 1118.

Secondary memory 1110 may include other means, devices, components, instrumentalities or other techniques for allowing computer programs and/or other instructions and/or data to be accessed by computer system 1100. Such means, devices, components, instrumentalities or other techniques may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
generating, by at least one processor, an embedding representation for a search query;
determining a set of candidate documents from a plurality of documents based on a comparison of the embedding representation to a plurality of document-level embedding representations, wherein each of the plurality of document-level embedding representations is representative of a document of the plurality of documents;
determining a subset of the determined set of candidate documents based on a comparison of the embedding representation to at least one of a respective plurality of section-level embedding representations for each candidate document of the determined set of candidate documents or a respective plurality of concept-level embedding representations for each candidate document of the determined set of candidate documents; and
outputting a response to the search query based on the subset.

2. The computer-implemented method of claim 1, wherein determining the subset comprises:
determining a first subset of the determined set of candidate documents based on a comparison of the embedding representation to the respective plurality of section-level embedding representations of each candidate document of the determined set of candidate documents; and
determining a second subset of candidate documents of the first subset based on a comparison of the embedding representation to a respective plurality of concept-level embedding representations of the candidate document of the first subset,
wherein outputting the response comprises outputting the response to the search query based on the second subset.

3. The computer-implemented method of claim 2, further comprising:
determining, utilizing a large language model, a level of specificity of the search query; and
for each candidate document in the second subset,
weighting a document-level embedding representation of the candidate document of the second subset, one or more section-level embedding representations of the candidate document of the second subset, and one or more concept-level embedding representations of the candidate document of the second subset based on the determined level of specificity of the search query,
wherein outputting the response comprises outputting the response based on the weighted document-level embedding representation of the candidate document of the second subset, the one or more section-level embedding representations of the candidate document of the second subset, and the one or more concept-level embedding representations of the candidate document of the second subset.

4. The computer-implemented method of claim 1, wherein a respective plurality of concept-level embedding representations of a particular candidate document of the determined set of candidate documents is generated by:
identifying, utilizing a large language model, a plurality of different concepts described in the particular candidate document; and
for each identified concept of the plurality of different concepts, generating a concept-level embedding for the identified concept.

5. The computer-implemented method of claim 1, wherein a respective plurality of section-level embedding representations for a particular candidate document of the determined set of candidate documents is generated by:
identifying different sections of text of the particular candidate document based on an organizational structure utilized by the particular candidate document;
for each identified section of the different sections of text, generating a chunk-level embedding representation representative of each chunk of text in the identified section; and
combining each chunk-level embedding representation to generate a respective section-level embedding representation of the respective plurality of section-level embedding representations.

6. The computer-implemented method of claim 1, wherein a respective plurality of section-level embedding representations for a particular candidate document of the determined set of candidate documents is generated by:
identifying different sections of text of the particular candidate document based on an unsupervised learning model configured to cluster text of the particular candidate document based on a level of similarity;
for each identified section of the different sections of text, generating a chunk-level embedding representation representative of each chunk of text in the identified section; and
combining each chunk-level embedding representation to generate a respective section-level embedding representation of the respective plurality of section-level embedding representations.

7. The computer-implemented method of claim 1, wherein a particular document-level embedding representation, of the plurality of document-level embedding representations, of a particular document of the plurality of documents is based on a combination of section-level embedding representations of the particular document.

8. A system, comprising:
a memory; and
at least one processor coupled to the memory and configured to:
generate an embedding representation for a search query;
determine a set of candidate documents from a plurality of documents based on a comparison of the embedding representation to a plurality of document-level embedding representations, wherein each of the plurality of document-level embedding representations is representative of a document of the plurality of documents;
determine a subset of the determined set of candidate documents based on a comparison of the embedding representation to at least one of a respective plurality of section-level embedding representations for each candidate document of the determined set of candidate documents or a respective plurality of concept-level embedding representations for each candidate document of the determined set of candidate documents; and
output a response to the search query based on the subset.

9. The system of claim 8, wherein, to determine the subset, the at least one processor is configured to:
determine a first subset of the determined set of candidate documents based on a comparison of the embedding representation to the respective plurality of section-level embedding representations of each candidate document of the determined set of candidate documents; and
determine a second subset of candidate documents of the first subset based on a comparison of the embedding representation to a respective plurality of concept-level embedding representations of the candidate document of the first subset,
wherein, to output the response, the at least one processor is configured to output the response to the search query based on the second subset.

10. The system of claim 9, wherein the at least one processor is further configured to:
determine, utilizing a large language model, a level of specificity of the search query; and
for each candidate document in the second subset,
weight a document-level embedding representation of the candidate document of the second subset, one or more section-level embedding representations of the candidate document of the second subset, and one or more concept-level embedding representations of the candidate document of the second subset based on the determined level of specificity of the search query,
wherein, to output the response, the at least one processor is configured to output the response based on the weighted document-level embedding representation of the candidate document of the second subset, the one or more section-level embedding representations of the candidate document of the second subset, and the one or more concept-level embedding representations of the candidate document of the second subset.

11. The system of claim 8, wherein the at least one processor is configured to generate a respective plurality of concept-level embedding representations of a particular candidate document of the determined set of candidate documents by:
identifying, utilizing a large language model, a plurality of different concepts described in the particular candidate document; and
for each identified concept of the plurality of different concepts, generating a concept-level embedding for the identified concept.

12. The system of claim 8, wherein the at least one processor is configured to generate a respective plurality of section-level embedding representations for a particular candidate document of the determined set of candidate documents by:
identifying different sections of text of the particular candidate document based on an organizational structure utilized by the particular candidate document;
for each identified section of the different sections of text, generating a chunk-level embedding representation representative of each chunk of text in the identified section; and
combining each chunk-level embedding representation to generate a respective section-level embedding representation of the respective plurality of section-level embedding representations.

13. The system of claim 8, wherein the at least one processor is configured to generate a respective plurality of section-level embedding representations for a particular candidate document of the determined set of candidate documents by:
identifying different sections of text of the particular candidate document based on an unsupervised learning model configured to cluster text of the particular candidate document based on a level of similarity;
for each identified section of the different sections of text, generating a chunk-level embedding representation representative of each chunk of text in the identified section; and
combining each chunk-level embedding representation to generate a respective section-level embedding representation of the respective plurality of section-level embedding representations.

14. The computer-implemented method of claim 8, wherein a particular document-level embedding representation, of the plurality of document-level embedding representations, of a particular document of the plurality of documents is based on a combination of section-level embedding representations of the particular document.

15. A non-transitory computer-readable device having instructions stored thereon that, when executed by at least one computing device, cause the at least one computing device to perform operations comprising:
generating, by at least one processor, an embedding representation for a search query;
determining a set of candidate documents from a plurality of documents based on a comparison of the embedding representation to a plurality of document-level embedding representations, wherein each of the plurality of document-level embedding representations is representative of a document of the plurality of documents;
determining a subset of the determined set of candidate documents based on a comparison of the embedding representation to at least one of a respective plurality of section-level embedding representations for each candidate document of the determined set of candidate documents or a respective plurality of concept-level embedding representations for each candidate document of the determined set of candidate documents; and
outputting a response to the search query based on the subset.

16. The non-transitory computer-readable device of claim 15, wherein determining the subset comprises:
determining a first subset of the determined set of candidate documents based on a comparison of the embedding representation to the respective plurality of section-level embedding representations of each candidate document of the determined set of candidate documents; and
determining a second subset of candidate documents of the first subset based on a comparison of the embedding representation to a respective plurality of concept-level embedding representations of the candidate document of the first subset,
wherein outputting the response comprises outputting the response to the search query based on the second subset.

17. The non-transitory computer-readable device of claim 16, further comprising:
determining, utilizing a large language model, a level of specificity of the search query; and
for each candidate document in the second subset,
weighting a document-level embedding representation of the candidate document of the second subset, one or more section-level embedding representations of the candidate document of the second subset, and one or more concept-level embedding representations of the candidate document of the second subset based on the determined level of specificity of the search query,
wherein outputting the response comprises outputting the response based on the weighted document-level embedding representation of the candidate document of the second subset, the one or more section-level embedding representations of the candidate document of the second subset, and the one or more concept-level embedding representations of the candidate document of the second subset.

18. The non-transitory computer-readable device of claim 15, wherein a respective plurality of concept-level embedding representations of a particular candidate document of the determined set of candidate documents is generated by:
identifying, utilizing a large language model, a plurality of different concepts described in the particular candidate document; and
for each identified concept of the plurality of different concepts, generating a concept-level embedding for the identified concept.

19. The non-transitory computer-readable device of claim 15, wherein a respective plurality of section-level embedding representations for a particular candidate document of the determined set of candidate documents is generated by:
identifying different sections of text of the particular candidate document based on an organizational structure utilized by the particular candidate document;
for each identified section of the different sections of text, generating a chunk-level embedding representation representative of each chunk of text in the identified section; and
combining each chunk-level embedding representation to generate a respective section-level embedding representation of the respective plurality of section-level embedding representations.

20. The non-transitory computer-readable device of claim 15, wherein a respective plurality of section-level embedding representations for a particular candidate document of the determined set of candidate documents is generated by:
identifying different sections of text of the particular candidate document based on an unsupervised learning model configured to cluster text of the particular candidate document based on a level of similarity;
for each identified section of the different sections of text, generating a chunk-level embedding representation representative of each chunk of text in the identified section; and
combining each chunk-level embedding representation to generate a respective section-level embedding representation of the respective plurality of section-level embedding representations.
